(19) United States
(12) Patent Application Publication
(10) Pub. No.: US 2011/0168822 A1
(43) Pub. Date: Jul. 14, 2011

(54) SHREDDING DEVICE FOR A SHREDDING PLANT

(75) Inventors: John Lester, Worksop (GB); Craig Rose, Sheffield (GB)

(73) Assignee: DANIELI DAVY DISTINGTON LTD., Sheffield (GB)

(21) Appl. No.: 13/001,189

(22) PCT Filed: Jun. 24, 2009
(86) PCT No.: PCT/EP09/57886

§ 371 Date: Mar. 15, 2011

(30) Foreign Application Priority Data
Jun. 26, 2008 (IT) UD2008A000152

(51) Int. Cl. B02C 13/28

(52) U.S. Cl. 241/191

(57) ABSTRACT

A shredding device comprising a drum having a central hub rotating around an axis on which a plurality of discoid elements are mounted adjacent, able to rotate solidly together and carrying peripherally beating elements. Each discoid element comprises a set of beating elements which comprises at least a pair of beating elements and, along the axis, the pairs of beating elements of the discoid elements are disposed angularly staggered with respect to the same axis.

### FIELD OF THE INVENTION

The present invention concerns a rotary shredding device that can be used in a plant for shredding, advantageously but not in limiting way of scrap, such as for example vehicles, trailers or other, in which the scrap is loaded whole and/or shredded so as to reduce the bulk and to sub-divide the different materials of which the scrap is made up, for example metal, glass, plastic or other. In particular, the rotary shredding device according to the present invention comprises at least a rotary drum along whose lateral surface a plurality of beating elements are peripherally pivoted, which are conformed so as to carry out the action of shredding the scrap.

### BACKGROUND OF THE INVENTION

Plants for shredding scrap are known, such as for example vehicles, trailers or other, in which the scrap is loaded substantially whole and is shredded, both to reduce the bulk and also to separate efficiently the materials that make it up.

Known plants for shredding scrap comprise a shredder unit provided with a shredding device, or drum, disposed rotatable around an axis of rotation inside a shredding chamber, and with respect to which the scrap is fed through a feed pipe.

The drum normally consists of a plurality of adjacent disks reciprocally constrained angularly, as for example in patent documents U.S. Pat. No. 4,310,125, U.S. Pat. No. 4,650,129 and in patent application US-A-2006/0226269. For every angular position, and on all the disks, a plurality of beating hammers are pivoted around respective rotation pins, substantially parallel to the axis of rotation of the drum, in determinate angular positions between the disks, in a peripheral zone of the drum.

The hammers are distributed on the length of the circular external surface of the drum, so as to form independent and homogeneous rows of hammers, separated angularly. The rows of hammers are aligned in directions that are all parallel to each other and parallel to the axis of rotation of the drum.

The hammers rotate independently with respect to each other and with respect to the drum, so as to pass independently from a first position outside the drum, an operating position in which they are able to beat the scrap, to a second position comprised within the bulk of the drum, which is an inoperative position.

Following the rotation of the drum, the hammers are loaded with an inertia such as to beat hard against the scrap, causing it to be shredded; after contact, they absorb the possible recoil by rotating autonomously with respect to the drum without discharging onto it any negative forces in its direction of rotation.

To every rotation of the drum there corresponds a determinate number of shredding blows on the scrap, equal to the number of rows and therefore to the number of angular positions of the hammers.

In the most common solution from 4 to 8 angular positions of the hammers are provided.

In the known solution, with every rotation of the drum, each row acts with its own hammers substantially simultaneously on the scrap, always hitting the same portions of scrap, not acting on the parts of scrap that are positioned between two adjacent hammers.

In this way, not all the parts of the scrap are subjected to an efficient shredding action, thus compromising the quality of separation of the materials, which is performed later.

Further solutions are also known from U.S. Pat. No. 5,213,73, from U.S. Pat. No. 5,505,393 and from U.S. Pat. No. 6,042,035, in which the hammers have a non-homogeneous disposition on the rows, also defining non-operative areas, that is, where the hammers are disposed not aligned in a precise rectilinear direction. In this known solution, the hammers hit the scrap alternately, thus varying the portions affected by the shredding action.

In these known solutions, respective protective shields are provided, associated externally with the disks that make up the drum. The protective shields are conformed in such a manner that, on the one side, they define a closed external surface in the zones where there are no hammers and, on the other side, they include apertures able to allow the hammers to rotate freely with respect to the drum.

In known solutions with non-homogeneous rows, the disposition of the hammers on every row, correlated to the conformation of the protective shields, is such that, with every complete rotation of the drum, some parts of the scrap are hit by one hammer only, other parts by two hammers, others are not hit at all and so on.

The shredding action on the scrap is therefore not uniform, which compromises the subsequent steps of separating the materials.

Another disadvantage of known solutions is that the material, shredded or to be shredded, tends to accumulate inside the drum, and over time begins to wear away the components which comprise the drum. In particular, in those solutions where the hammer rotates past a central hub located between the discs inside the drum, the material can be trapped between a hammer and a disc hub, which gradually removes material from the hub towards the inside of the seating, following the progressive wearing of the seating itself. This erosion of the internal drum components is particularly dangerous and reduces the life of the drum. Continuous replacement of the component material is required, undertaken by welding at great cost.

The known solutions also have the disadvantage that the pins around which the hammers are rotatably connected, usually made of metal, tend to deform with use due to the force applied by the hammer. In particular, it causes a deformation with humps at the sides of the hammer; over time and several hammer change cycles, this limits and impedes the replacement of the hammer shaft, making replacement of the hammers time consuming and expensive. Usually, to solve the problem, it is necessary to cut the hammer shaft with a burning torch to free the worn hammer. The typical solution exhibited by the state of the art would be to have a hydraulically actuated shaft removal means, exerting a massive force to shear the deformations off the damaged shaft, the risk being that the drum inside the machine can become misaligned within the housing of the drum.

Another disadvantage of known solutions is that the scrap tends to slide away, due to the rotation of the drum, while it is being shredded, along the protective shields, so that the case occurs where the scrap does not completely receive the expected blow from the hammer, since it has moved, returning back, for example, along the feed chute.

Purpose of the present invention is to achieve a shredding device which solves the disadvantages of the state of the art, in particular so as to allow a uniform distribution of the hammer blows on the scrap, both longitudinally along the axis of the drum, and also for each sector or discoid module of the drum.

Another purpose of the invention is to achieve a shredding device which will reduce or eliminate the risks of blockages or interference by the hammer with the shredded scrap and debris that accumulate inside the drum.

Another purpose of the present invention is to achieve a shredding device that resists the mechanical stresses of the hammers, thus reducing or eliminating operations of maintenance or restoration on the connection pins of the hammers.

Finally, another purpose of the invention is to achieve a shredding device by means of which the scrap or material to be shredded is effectively maintained in the optimum position to receive the hammer blows, without sliding away from said position.

### SUMMARY OF THE INVENTION

The present invention is set forth and characterized in the independent claim, while the dependent claims describe other characteristics of the invention or variants to the main inventive idea.

A shredding device according to the present invention comprises, typically, a drum having a central hub that is rotary around a longitudinal axis, on which a plurality of discoid elements are mounted adjacent, able to rotate solidly together and having on their periphery beating elements to shred the scrap.

According to a first characteristic of the present invention, each discoid element comprises a set of beating elements which comprises at least a pair of beating elements and, along the axis, the sets of beating elements of the discoid elements are disposed angularly staggered with respect to said axis.

Thanks to this disposition of the beating elements, with the present invention we have a uniform distribution of blows on the scrap, both longitudinally along the axis of the drum, and also for each discoid element of the drum. The scrap is hit, at the same point consecutively at least twice for each discoid element of the drum, and along the axis of the drum, the scrap is hit the same number of times, with every complete rotation, but in a staggered manner and not simultaneously, so as to obtain the desired uniformity of impact.

According to one embodiment of the present invention, making reference to the same angular position, the pairs of beating elements are disposed, in relation to said angular position with respect to the axis of rotation of the drum, on relative discoid elements separated by one or more other discoid elements, so as to determine an alternate development thereof In other words, there are no adjacent discoid elements that, in the same angular position, have beating elements. There may be discoid elements that in the same angular position have beating elements, however, according to the present invention, they are not directly adjacent.

Typically, each beating element is pivoted peripherally, with one constraining end, to a relative discoid element by means of a pin, so that the beating elements rotate independently from each other and from the drum, and are able to pass independently from a first position outside the drum, an operating position in which they are able to hit the scrap, to a second position comprised within the bulk of the drum, an inoperative position, and vice versa.

According to a second characteristic of the present invention, the discoid elements are assembled to each other by means of central connection elements, so as to define, for each pair of discoid elements, a central interstice in which the beating element is comprised in the second position. Each connection element has a plurality of surface inside the interstice, each of which faces towards a corresponding beating element. Each of said surfaces is made with a curvilinear profile mating with a corresponding curvilinear profile present on a free end of each beating element, opposite the constraining end, so as to define, when the surface of the connection element and the free end of the beating element are facing in the second position, an interspace of constant size. According to a preferential embodiment, the profile of the surface of the connection element and of said free end is a predetermined arc of a circumference.

Thanks to the particular mating curvilinear profiles, preferably shaped like the arc of a circle, the risks of blocking or interference of the beating element with the shredded scrap and debris that can accumulate inside the drum are reduced or eliminated, preventing the formation of accumulations of shredded scrap of the wedge type.

According to a third characteristic of the present invention, each connection pin of the beating elements is provided with a determinate portion around which one of the beating elements is rotatably mounted, which is made of metal having a greater hardness than the metal of which the remaining part of the pin is made.

Thanks to the great hardness of the material around which the beating element is rotatably coupled, the supporting pin resists the mechanical stresses of the beating elements, reducing or eliminating operations of maintenance or restoration on the connection pins of the hammers. The hump-type deformations of the shaft adjacent to the hammer, typical of the state of the art, will be substantially reduced. A knock on effect will be a reduction in the installed hydraulic power of the shaft removal means.

Typically, the shredding device comprises protection elements disposed on the lateral external surface of the drum, in a complementary manner to the beating elements, so as to cover substantially all said lateral surface leaving relative windows free for the passage of the beating elements.

According to a fourth characteristic of the present invention, each of the protection elements has externally gripping and friction means, preferably conformed as trapezoid blocks which extend radially outwards. The gripping means allows the scrap, during the rotation of the drum, to be effectively accelerated radially outwards, towards the separation elements housed inside the shredder chamber, causing accelerated sizing of material to such a level that it can be quickly ejected from the machine.

### BRIEF DESCRIPTION OF THE DRAWINGS

These and other characteristics of the present invention will become apparent from the following description of a preferential form of embodiment, given as a non-restrictive example with reference to the attached drawings wherein:

FIGS. 1a, 1b and 1c are front views of a shredding device according to the present invention in three different operating conditions, rotated by about 60° one with respect to the other;

FIGS. 1d, 1e and 1f are lateral views corresponding respectively to FIGS. 1a, 1b and 1c;

FIG. 2 is a schematic representation of the disposition of the beating elements in the present invention;

FIG. 3 is an enlarged detail of a cross section of FIG. 1a;

FIG. 4 is a lateral view of a part of the shredding device according to the present invention;

FIG. 5 is a partly sectioned lateral view of the shredding device according to the present invention;

FIG. 6 is another enlarged detail of a cross section of FIG. 1a.

### DETAILED DESCRIPTION OF A PREFERENTIAL FORM OF EMBODIMENT

With reference to the attached drawings, a rotary shredding device 10 according to the present invention is able to be used inside a shredding chamber in a plant for shredding scrap, only partly visible in FIG. 5 and indicated by the reference number 50, with respect to which the scrap is fed through a feed pipe 38.

The device 10 comprises at least a rotary drum 11 of the modular type, consisting of a plurality of discoid elements, or modules 13, adjacent and kept together in a known manner, attached to a central hub 12.

The hub 12 is made to rotate, in a traditional manner, by drive means not shown in the drawings, around a longitudinal axis X for the rotatable movement of the drum 11 of the shredding device 10.

Along the lateral surface of the drum 11 a plurality of beating hammers 14 are pivoted peripherally, as will be described hereafter in more detail, which are conformed so as to effect the shredding action on the scrap fed inside the shredding device 10.

The shredded scarp is than screened by means of screening/sizing means 39.

The spaces between one hammer 14 and the other, on the lateral surface of the drum 11, are covered by protective shields 16, with a protective function as is known in the state of the art and which cover the whole drum, except for windows 35 for the passage of the hammers 14.

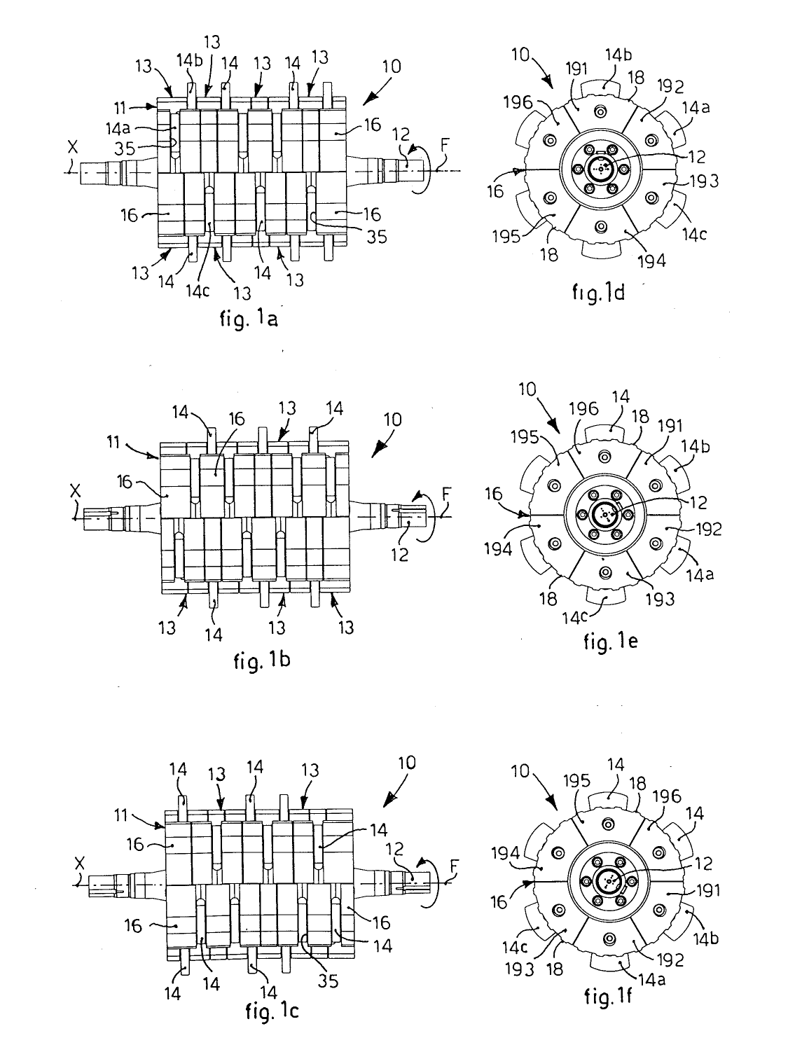

In the specific case of FIGS. 1a, 1b, 1c, 1d, 1e and 1f, there are ten modules 13 mounted adjacent on the hub 12. The modules 13 are mounted distanced from each other, so as to define a central interstice 29 for each pair of adjacent modules 13. The modules 13 are assembled by means of plates 20, installed centrally in the interstices 29, coaxial with the hub 12.

In this case, each module 13 has two hammers 14.

With every complete rotation of the drum 11, the hammers 14 perform a uniform shredding action on the scrap, because each part of the scrap is hit a predetermined number of times, in this case twice.

Typically, the two hammers 14 of each module 13 are attached symmetrically with respect to the axis X, that is, on opposite sides at 180° with respect to the axis X.

Furthermore, with reference to a single hammer 14 of each module 13 for ease of explanation, although the following applies also to the symmetrical hammer 14, the other hammers 14 of the remaining modules 13 are disposed in determinate angular positions with respect to the axis X, staggered with respect to each other by a determinate angular value with respect to the reference hammer 14, in this case by 60°, so that they are not aligned with a determinate rectilinear direction and parallel to the axis X. This angularly staggered disposition of the hammers 14 is clear, for example, by comparing FIGS. 1a and 1d, where it can be seen that a first hammer 14a, on the left, is inclined by 60°, a second hammer 14b is in a 12 o'clock position, that is, not inclined, a third hammer 14c is inclined by 120° and so on.

This type of angularly staggered disposition, in this case by 60°, is also repeated for every symmetrical hammer 14 of each drum 13, so as to have a uniform and angularly staggered disposition of the hammers 14.

In this way, with every complete rotation of 360° of the drum, the scrap is hit both an equal number of times in the same position, in this case twice, by the hammers 14 of every module 13, and also overall, on the axial length of the drum 11, uniformly, but not simultaneously, by all the hammers 14.

In particular, each module 13 is divided into a plurality of angular sectors 191, 192, 193, 194, 195, 196, in this case six sectors, as can be seen in FIGS. 1d, 1e and 1f, two of which, symmetrical to the axis X, have a relative hammer 14.

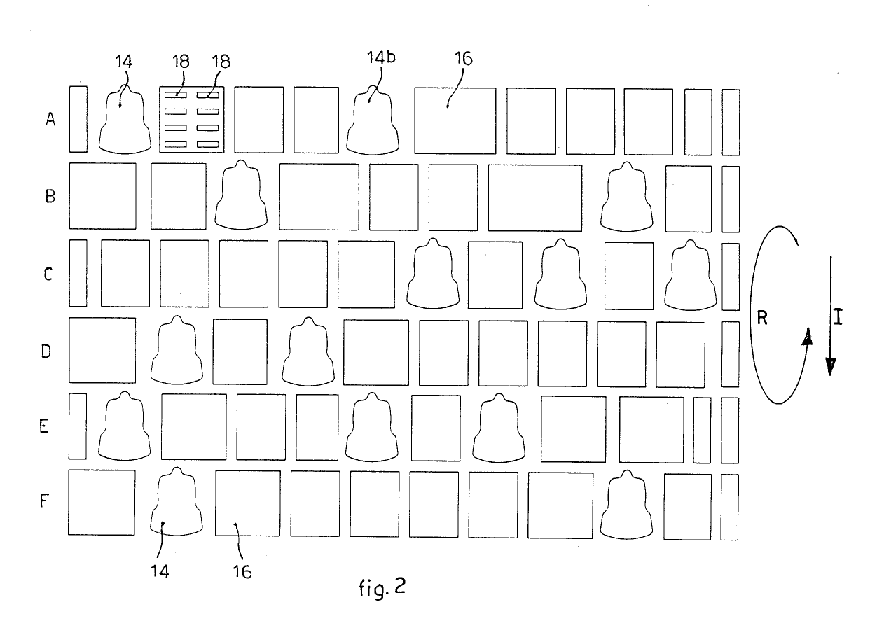

FIG. 2 shows a schematic lay-out, developing plane, of the positioning of the hammers 14 on the lateral surface of the drum 11. The arrow I shows the direction of impact of the drum 11 on the scrap to be shredded.

In this case, considering the various angular sectors 191, 192, 193, 194, 195, 196, for each angular position, six groups of angular sectors can be identified horizontally, indicated by the letters A, B, C, D, E and F in FIG. 2.

The vertical columns, obviously, indicate the various adjacent discoid elements 13. As can be seen, each discoid element 13 in this case always has two hammers 14. It is essential for the present invention that the number of hammers 14 is the same, and greater than one, for each discoid element 13.

Group B of angular sectors corresponding to the position of 12 o'clock in FIG. 1d, indicated by 191, has the hammers 14 that are in the second, fourth, eighth and tenth sector 192, as can be seen in FIG. 1.

Group C of angular sectors 192, immediately after in a clock-wise direction to the sectors 191, has the hammers 14 in the first, fifth and seventh sector 192 (FIG. 1a).

Group D of angular sectors 193, immediately after in a clock-wise direction to the sectors 192, has the hammers 14 in the third, sixth and ninth sector 193 (FIG. 1a).

The other groups E, F and A of sectors 194, 195 and 196 are the same, respectively, as groups B, C and D.

FIGS. 1a, 1b and 1c, and the corresponding lateral views 1d, 1e and 1f, show three consecutive rotations, as indicated by the arrow F, of an angular amplitude equal to 60°, by means of which the sector 191 is taken from the starting position at 12 o'clock in FIG. 1a to the diametrically opposite position of 6 o'clock in FIG. 1c.

By putting the various modules 13 thus designed adjacent to each other, we obtain a complete and uniform disposition of the hammers 14 along the axis X. With every rotation, an angular sector 19 of each module 13 is taken towards the scrap. The angular sectors 19 that have a hammer 14 hit the scrap, the others do not, and so on, as the drum 11 gradually rotates. At the end of the rotation, all the angular sectors are taken towards the scrap, and all of them have hit the scrap twice by means of the relative hammers 14, even if not simultaneously.

In this way, the hammers 14 hit the scrap alternately, thus varying the portions affected by the shredding action.

Each of the hammers 14 is mounted, freely rotatable, on a rotation pin 17 made of metal.

In particular, there is an angular constraint between a seating 27 of one end 25 of the hammer 14 and a portion of the pin 17. In this way, as is known in the state of the art, the hammers 14 rotate independently from each other and from the drum 11, and as a consequence of the rotary motion of the drum 11, they can pass independently from a first position outside the drum 11, an operating position in which they are able to hit the scrap, to a second position comprised within the bulk of the drum 11, an inoperative position, and vice versa.

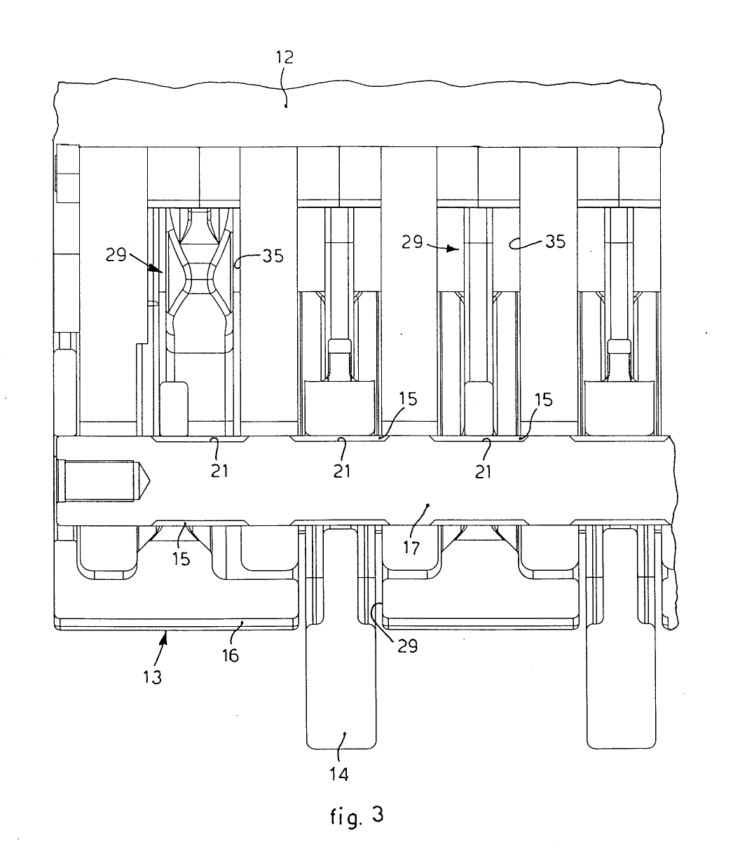

Typically, each pin 17 is installed in the desired angular positions as shown above, along the peripheral circumference of each of the modules 13 of the drum, between one module 13 and the other, so as to define a desired amplitude for said interstices 29 (FIGS. 1a, 1b, 1c and 3) able to accommodate the hammer 14 when it again moves to its non-operative position.

In the portions where the hammers 14 are angularly constrained, the pin 17 has an annular hollow 21 in which an annular element 15 is disposed, around which the hammer 14 is pivoted, made of a different metal from that of which the pin 17 (FIG. 3) is made, and harder than this. In this way, the hump-shaped deformations due to the tensions applied repeatedly by the hammer, which are typical of pins in the state of the art, can be reduced or eliminated.

According to another characteristic of the present invention, each hammer 14 has an active end 32, opposite the end 25 where it is angularly constrained to the pin 17. The active end 32, in the first operating position of the hammer 14, is able to hit the scrap, whereas in the second position, non-operative, it is inside the drum 11, in particular passing through the window 35 and inserting itself, rotating, into the interstice 29.

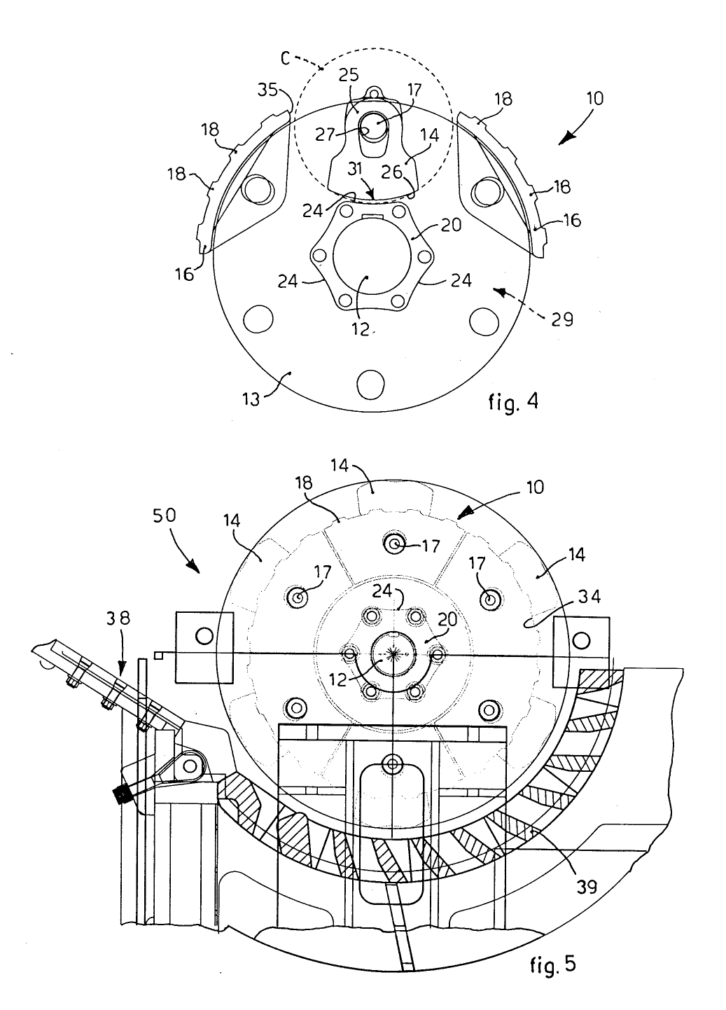

The active end 32 has a curved peripheral profile 26; preferably it is substantially an arc of a circumference C (FIG. 4), although it can have a central recess 33 as shown in FIG. 5. What must be noted is that the peripheral bulk of the active end 32 lies along an arc of a circumference C. The center of the circumference C can coincide with the center of the pin 17 around which the hammer 14 rotates. Typically, however, the center of the circumference C is different from the center of the pin 17.

FIG. 4 shows, for convenience, only one hammer 14 and two protective shields 16, but it is clearly understood that the other hammers 14 and the other protective shields 16 are also present so as to complete the whole.

According to the present invention, the plates 20 between one module 13 and the other are also conformed as angular sectors, in precise correspondence with the angular positions of the hammers 14, which have a curvilinear surface 24 mating with the profile 26, substantially the arc of a circumference, of the active end 32 of the relative hammer 14.

The profile 26 and the surface 24 thus have a coherent and mating development.

Consequently, the curvilinear surface 24 is also an arc of a circumference, in particular of the same circumference C, as seen in FIG. 4. The assembly position of the hammer 14, that is, the distance of its constraint from the center of the drum 11, is such that, in the second position inside the drum 11 as shown in FIG. 5, the profile 26 defines an annular slit 31, with a constant height, with the curvilinear surface 24 of the plate 20. Therefore, there is no excessive accumulation of shredded scrap in the annular slit 31, in particular preventing the harmful wedge-shaped conformations of the scrap, typical of the state of the art, and preventing the risk of blocking the hammer 14. In fact, even if scrap is accumulated, this occurs uniformly following the arc of the circumference C and for a limited height, without interferences, edges or variations in the inclination of the rotation of the hammer 14. Furthermore, thanks to its arc-shaped profile 16 perfectly mating with the curvilinear surface 24 of the plate 20, the hammer 14 can easily clear away the excess scrap which would obstruct the annular slit 31, not finding excessive resistance in the scrap.

This embodiment of the present invention can also be adopted for pairs of modules 13 that have a solid central body, and peripheral seatings in which the hammers 14 rotate. In this case the solid central body is to be taken, instead of the plates, as the central connection element between the two modules 13, which has peripherally, in correspondence with the bottom of said seatings, said surfaces 24 shaped like the arc of a circumference.

According to another feature of the present invention, the protective shields 16 have externally gripper elements 18, for example conformed as a parallelepiped with a trapezoid section, which protrude externally from the plane surface of the protective shield 16.

The gripper elements 18 function as a gripper and increase the friction between the drum 11 and the scrap (FIG. 4), so as to radially accelerate the shredded scarp in direction of screening/sizing means 39. The height of the gripper elements 18 is a fraction less than the complete extension of the hammers 14, indicated by the theoretical circumference 22 outside the drum 11 in FIG. 5. The disposition of the gripper elements 18 on the module 13 and along the drum 11 is substantially homogeneous and uniform, although the individual sizes of each gripper element 18 can vary, as can the interspace between one gripper element 18 and the other, so as to have the desired level of friction. In this case, the gripper elements 18 are disposed uniformly, at regular intervals, along an ideal internal circumference 34 of the drum 11 (FIG. 5).

In FIG. 2, the gripper elements 18 are shown for convenience on a single protective shield 16, but it is understood that all the protective shields 16 in FIG. 2 can have said gripper elements 18.

In this way, even if the zones with the protective shields 16 do not have hammers 14, they are in any case active in the shredding action, ensuring an efficient grip on the scrap and keeping the scrap in the desired position, for the desired period of time in which the hammer 14 has to hit the scrap. Consequently, the scrap does not slide away, and in particular it does not turn back, when the drum 11 rotates towards it in order to hit it. In this way, the power of the blow of the hammer 14 is fully exploited, over the whole surface of the scrap.

Consequently, the scarp is accelerate in direction of the screening/sizing means 39, such a way the size is accelerate, thus permitting the fast discharge of the shredded scarp.

An advantageous solution of the present invention provides that the protective shields 16 are made in modular fashion and complementary with each other, according to a predetermined pattern and with a determinate number of types of modules, for the overall definition of the cover.

Clearly, the cover pattern is complementary to the pattern according to which the hammers 14 are disposed. Once the necessary pattern of the hammers 14 has been defined in the design stage, the relative cover is constructed by means of the shields 16.

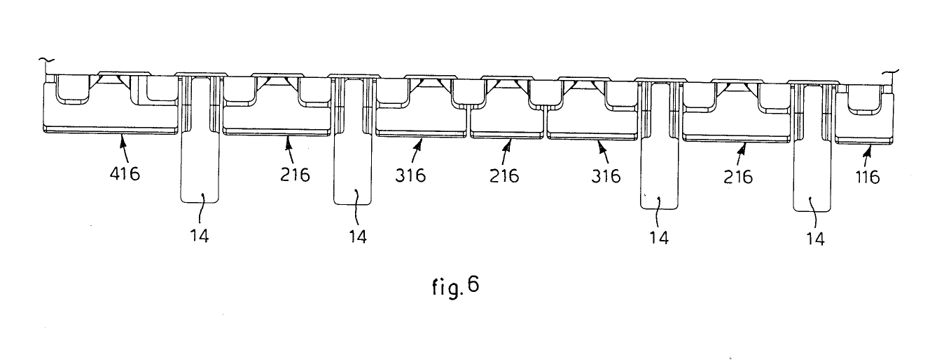

In particular, there are four types of protective shields, 116, 216, 316 and 416, all of which have a cross section having a seating 36, facing towards the inside of the drum 11, able to house part of the discoid element 13 and a horizontal external wall 37, the cover proper, of a length variable according to the surface of the drum 11 to be protected (FIG. 6), so as to define an overall section which can be U-shaped (shield indicated by 116), T-shaped, symmetrical (shield indicated by 216), or asymmetrical (shield indicated by 316), or a horizontal F (shield indicated by 416). It is clear the U-shaped sections and T-shaped sections are straight or upside down, depending on the assembly position in the drum 11.

This gives the advantage that, according to the desired disposition of the hammers 14, it is possible to design the cover with the protective shields in modular manner, using a limited number of types of shield 16, which can be interconnected with each other according to determinate patterns, therefore reducing the number of types of pieces that have to be kept in the warehouse for possible maintenance.

It is clear, however, that modifications and/or additions of parts may be made to the shredding device 10 as described heretofore, without departing from the field and scope of the present invention.

It is also clear that, although the present invention has been described with reference to some specific examples, a person of skill in the art shall certainly be able to achieve many other equivalent forms of shredding device for a shredding plant, having the characteristics as set forth in the claims and hence all coming within the field of protection defined thereby.

1. A shredding device comprising a drum having a central hub rotating around an axis on which a plurality of discoid elements are mounted adjacent, able to rotate solidly together and carrying peripherally beating elements, wherein each discoid element comprises a set of beating elements which comprises at least a pair of beating elements and wherein, along the axis, the beating elements of the pair of one discoid elements are disposed angularly staggered with respect to the beating elements of the pair of the discoid element(s) immediately adjacent to said one discoid element.

2. The shredding device as in claim 1, wherein the pairs of beating elements are disposed, relative to a predetermined angular position with respect to the axis, on relative discoid elements separated by one or more other discoid elements so as to determine an alternate development thereof.

3. The shredding device as in claim 1, wherein the beating elements of each discoid element are mounted in a diametrically opposite position, at 180°, with respect to the axis.

4. The shredding device as in claim 1, wherein each discoid element is divided into several angular sections, disposed around the axis, in which one of said beating elements is mounted on at least two of said angular sectors of each discoid element.

5. The shredding device as in claim 4, wherein the device provides groups of angular sectors associated with the same angular position with respect to the axis, each of which has, overall, a series of beating elements with a predefined and alternate cadence along the axis, which are mounted on discoid elements separated by one or more discoid elements.

6. The shredding device as in claim 5, wherein the sum of the beating elements for each group of angular sectors is greater than one and less than the number of the discoid elements.

7. The shredding device as in claim 5, wherein the angular sectors are each provided with a predetermined angular amplitude, in which the number of beating elements mounted overall on a number of groups of adjacent angular sectors and equal to half the groups of angular sectors is equal to the number of discoid elements.

8. The shredding device as in claim 5, wherein the angular sectors are each provided with an angular amplitude of 60°.

9. The shredding device as in claim 5, wherein there are eleven discoid elements.

10. The shredding device as in claim 1, wherein each beating element is peripherally pivoted, with a constraining end, to a relative discoid element by means of a pin, so that the beating elements are able to rotate independently from each other and from the drum, and are able to pass independently from a first position outside the drum, an operating position in which they are able to hit the scrap, to a second position comprised within the bulk of the drum, a non-operating position, and vice versa.

11. The shredding device as in claim 10, wherein the discoid elements are assembled with each other by means of central connection elements, so as to define, for each pair of discoid elements, a housing seating in which each beating element is comprised in the second position, in which each connection element has a plurality of surfaces, each of which faces towards a corresponding beating element, each surface having a curvilinear profile mating with a curvilinear profile present on a free end of each beating element, opposite the constraining end, so as to define, when the surface and the free end are facing in the second position, an interspace of constant size.

12. The shredding device as in claim 11, wherein the curvilinear profile of each surface of the connection element and the curvilinear profile of the free end of each beating element coincide with a predetermined arc of a circumference.

13. The shredding device as in claim 10, wherein each pin comprises a determinate portion around which one of the beating elements is rotatably mounted, which portion is made of a metal material with a greater hardness than that of the metal material of which the remaining part of the pin is made.

14. The shredding device as in claim 1, comprising protection elements disposed on the external lateral surface of the drum in a manner complementary to the beating elements, so as to cover substantially the whole of said lateral surface, leaving free relative windows for the passage of the beating elements.

15. The shredding device as in claim 14, wherein each of the protection elements has externally gripper and friction means.

16. The shredding device as in claim 14, wherein the protection elements each have a cross section having a seating facing towards the inside of the drum, able to accommodate part of the discoid element and a horizontal external wall, of variable length according to the surface of the drum to be protected, so as to define an overall section that can be U-shaped, T-shaped, symmetrical, or asymmetrical, or horizontal F-shaped.
